(19) United States
(12) Patent Application Publication
(10) Pub. No.: US 2004/0250866 A1
(43) Pub. Date: Dec. 16, 2004

(54) Pressure medium reservoir

(75) Inventors: Thomas Bartsch, Niedernhausen (DE); Gottfried Dehio, Hanau (DE); Hans-Dieter Reinartz, Frankfurt/Main (DE); Marco Muller, Lahnau (DE); Martin Baechle, Glashutten (DE); Uwe Greiff, Bad Homburg (DE); Ronald Kley, Seligenstadt (DE); Sven Martin, Schwetzingen (DE); Hartmut Diether, Frankfurt am Main (DE)

Correspondence Address: RADER, FISHMAN & GRAUER PLLC, 39533 WOODWARD AVENUE, SUITE 140, BLOOMFIELD HILLS, MI, 48304-0610, US

(73) Assignee: Continental Teves AG & Co. OHG, Frankfurt am Main (DE)

(21) Appl. No.: 10/492,503

(22) PCT Filed: Oct. 9, 2002
(86) PCT No.: PCT/EP02/11288

(30) Foreign Application Priority Data
Oct. 16, 2001 (DE) 101 51 041.1
Oct. 16, 2001 (DE) 101 51 050.0
Nov. 22, 2001 (DE) 101 57 146.1
Apr. 4, 2002 (DE) 102 14 871.6

(51) Int. Cl. F16L 55/04

(52) U.S. Cl. 138/30

(57) ABSTRACT

A pressure fluid accumulator with a housing having its interior subdivided by a media-separating element into two chambers, the first chamber being filled with a gas and the second chamber being filled with a liquid, and wherein in a hydraulic port a bottom valve is provided which permits filling the second chamber with liquid and prevents complete evacuation of the second chamber, and the valve's closure member is operable by the media-separating element. In order to prevent, especially at low temperatures and high viscosity of the pressure fluid, damage of the media-separating element caused by a high differential pressure, a device is provided between the media-separating element and the bottom valve.

### TECHNICAL FIELD

The present invention generally relates to pressure fluid accumulators and more particularly relates to a pressure fluid accumulator with a housing having its interior subdivided by a media-separating element into two chambers, the first chamber being filled with a gas and the second chamber being filled with a liquid.

### BACKGROUND OF THE INVENTION

A pressure fluid accumulator of this type is disclosed in international patent application WO 00/31420. The bottom valve of the prior-art pressure fluid accumulator is composed of an elastic sealing element, which upon closing cooperates with a conical annular surface designed in the bore of the hydraulic port. The closing operation takes place in two phases. In the first phase, in which the pressurized pressure fluid flows past the sealing element, the closure member of the bottom valve is pushed so far downwards by the media-separating element until the sealing element comes into contact with the conical annular surface and prevents the exit of the pressure fluid out of the second chamber. In the subsequent second closing phase, the closure member fulfils the function of a hydraulic piston that is displaced further in a downward direction due to the residual pressure acting in the second chamber.

When the pressure fluid cools down after closure of the bottom valve, the media-separating element will move further downwards in the direction of the bottom valve. If, however, it comes to a rest in the direct vicinity of the closure member of the bottom valve, it is not possible to completely open the bottom valve in the subsequent filling operation so that the fluid must pass over the sealing element fitted to the closure member. Because the slot bounded by the wall of a bore that accommodates the closure member and by the sealing element is very small, a high differential pressure is necessary for the filling operation, in particular at low temperatures and high viscosity of the pressure fluid. Consequently, a high amount of hydraulic force acts on the closure member, urging the closure member against the bottom of the media-separating element. This produces a relatively great pressure difference, up to 10 bar, between the two chambers, with the imminent risk of damage of the media-separating element. Due to this drawback, in many instances, it is not possible for the prior-art pressure fluid accumulator to reach their useful life.

### BRIEF SUMMARY OF THE INVENTION

In view of the above, an object of the present invention is to improve upon a pressure fluid accumulator of the above-mentioned type to such effect that damage of the media-separating element during the filling operation is prevented to the greatest extent possible and, thus, a considerable increase in the operational safety is safeguarded.

According to the present invention, this object is achieved in that a means for reducing the force that can be transmitted from the closure member of the bottom valve to the media-separating element is provided between the media-separating element and the bottom valve.

To render the idea of the present invention more precise, the means is configured as a spring, preferably a compression spring being supported on the closure member of the bottom valve and movable into abutment on the media-separating element.

In a favorable aspect of the object of the invention, the compression spring abuts on the media-separating element by means of a force-transmitting member that is slidably guided in the closure member. In this arrangement, the closure member is preferably preloaded in opposition to the closing direction by means of a valve spring whose spring rate is lower than the spring rate of the compression spring.

Further favorable features of the present invention are stated in sub claims 4 to 18.

### BRIEF DESCRIPTION OF THE DRAWINGS

FIG. 1 is an axial cross-sectional view of an embodiment of the pressure fluid accumulator of the invention with the bottom valve closed.

FIG. 2 is an enlarged view of the bottom valve of the pressure fluid accumulator in its open condition according to FIG. 1.

FIG. 3 is an enlarged view of a second embodiment of the bottom valve in its open condition.

FIGS. 4a,b is a view of a third embodiment of the bottom valve in its open and closed conditions.

FIG. 5a,b is a fourth to seventh embodiment of the

through 8a,b bottom valve in its open and closed conditions.

FIGS. 9a-d show phases of operation of an eighth embodiment of the bottom valve of the invention.

FIGS. 10a-d show the phases of operation according to FIGS. 9a-d in a ninth embodiment of the bottom valve of the invention.

FIGS. 11a,b show a tenth embodiment of the bottom valve in its open and closed conditions.

FIGS. 12a,b show an eleventh embodiment of the bottom valve in its open and closed conditions.

### DETAILED DESCRIPTION OF THE PREFERRED EMBODIMENTS

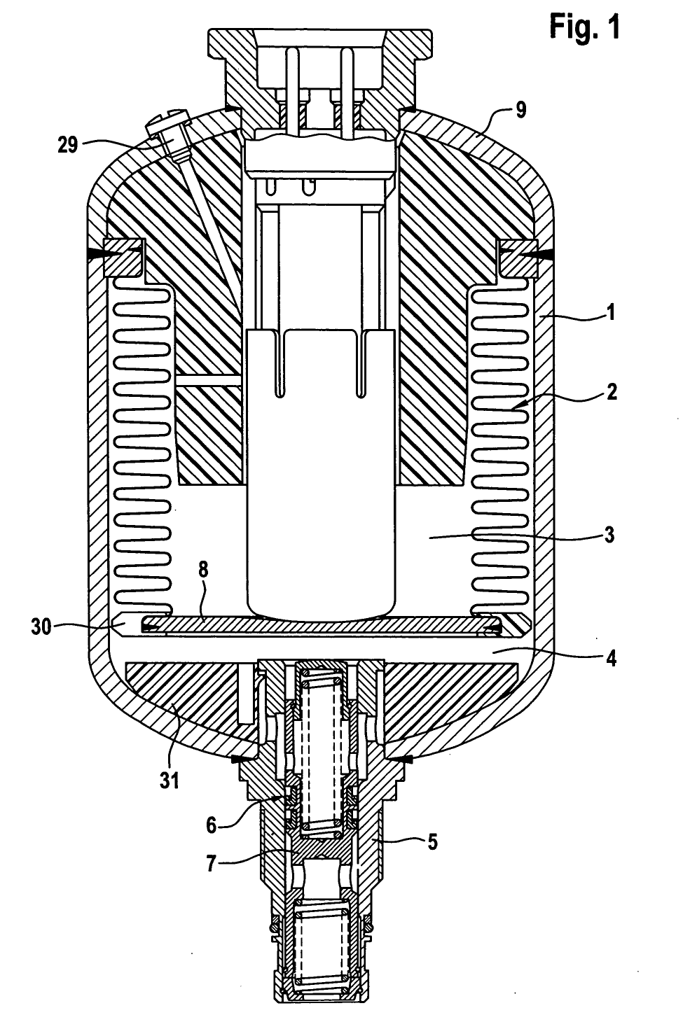

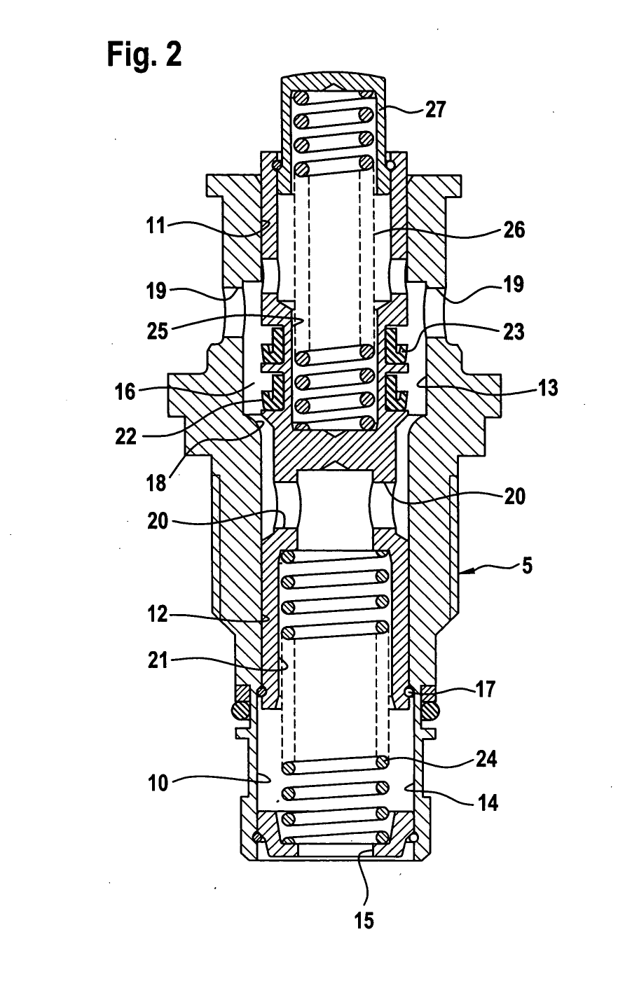

The pressure fluid accumulator of the present invention as illustrated in FIG. 1 has a housing 1, with its interior subdivided into two pressure compartments or chambers 3, 4 by means of a media-separating element 2. The media-separating element 2 is preferably formed by a thin-walled metallic pleated bellows, which is connected pressure-tightly to a cover 9 that closes the housing 1, on the one hand, and is closed by a plate 8, on the other hand. The interior of the pleated bellows 2 houses the first chamber 3, which can be filled with a gas that is generally under high pressure by way of a fill port 29 provided in the cover 9. In the bottom part of the housing 1, a hydraulic port 5 is provided in which a bottom valve 6 is arranged whose closure member 7 projects into the second chamber 4 in the open position of the bottom valve (FIG. 2). The bottom valve 6 is preferably configured so that it permits filling the second chamber 4 with a pressurized fluid, such as a brake fluid, on the one hand, and prevents complete evacuation of the second chamber 4, on the other hand. To achieve centering of the pleated bellows 2 in the housing 1, there is provision of a slotted ring 30 which embraces the plate 8 and the edge of which is at a small distance from the wall of housing 1 in the mounted condition. To minimize the pressure fluid volume uptake of the second chamber 4, a fill member 31 is arranged at the bottom of housing 1.

As can be taken from FIG. 2 in particular, the hydraulic port 5 that includes a fill or discharge opening 15 has a bore 10 designed as a stepped bore and comprising four portions. While two portions 11, 12 of equal diameter are used to guide the closure member 7, a larger-diameter third portion 13 is provided between them, bounding an annular chamber 16 along with the closure member 7. A fourth portion 14 designed at the bottom end of port 5 accommodates a circular clip 17 arranged at closure member 7 and used to limit the movement of the closure member 7 in the opening direction of the bottom valve 6. The transition area between the portions 12, 13 is preferably a conical annular surface 18. The above-mentioned annular chamber 16 is in connection with the second chamber 4 by means of radial passages 19, while closure member 7 includes several radial flow ducts 20 being connected to the fill or discharge opening 15 of the hydraulic port 5. The last mentioned connection is established through a cylindrical recess 21 designed in the closure member 7 and accommodating a valve spring 24 that preloads the closure member 7 in the opening direction of the bottom valve 6. Two sealing elements 22, 23 arranged one behind the other at closure member 7 and being preferably configured as sealing cups that provide a sealing against the wall of portion 12 in the closing operation of the bottom valve 6.

A second cylindrical recess 25 that is provided at the end of the closure member 7 remote from the fill and discharge opening accommodates a spring, preferably a compression spring 26, whose spring rate is considerably higher than the spring rate of the above-mentioned valve spring 24. The compression spring 26 which is supported on the bottom of the cylindrical recess 25, on the one hand, bears at its other end against a force-transmitting member 27, which is slidably guided in the closure member 7 and cooperates with the plate 8 that closes the pleated bellows 2 in the closing operation.

Closing of the bottom valve 6 takes place in two phases. Shortly before the evacuation of the chamber 4, the plate 8 that closes the pleated bellows 2 starts touching the force-transmitting member 27. Because the strength of the compression spring 26, as mentioned above, exceeds the strength of the valve spring 24, the closure member 7 upon further discharge of pressure fluid is displaced in opposition to the force generated by the valve spring 24 or urged downwards in the drawing until the outside sealing lip of the first sealing cup 22 moves into contact with the wall of the stepped bore portion 12 and, thus, prevents fluid circulation around the closure member 7. The closure member 7 starts in this moment to fulfill the function of a hydraulic piston and is displaced further downwards by the residual pressure that prevails in the chamber 4. This causes also displacement of the second sealing cup 23 into portion 12 sealing towards its wall.

The bottom valve 6 is opened because liquid pressure fluid is pumped from the outside into the pressure fluid accumulator 1 according to the invention. When the charging pressure exceeds the residual pressure or internal pressure that prevails in the chamber 4 (ignoring the opening force of the compression spring 24 and closing force of the sealing cup friction), the closure member 7 is moved in the opening direction, discharging already its own displacement volume into the second chamber 4. When the force-transmitting member 27 comes into abutment on the plate 8 of the media-separating element before the sealing cups 22 and 23 open the entry to chamber 4, the dynamic pressure on the outside will rise because now the sealing cup 22 or the sealing cups 22 and 23 together must be overflown. By way of the effective surface of the closure member 7, this dynamic pressure increase causes a force that is supported on the plate 8 of the media-separating element. When this flow force, caused by the fluid penetration through the narrow slot, becomes greater than the preloading force produced by spring 26, the force applied to the plate 8 will be limited by this part because the force-transmitting member 27 is urged into the hydraulic port 5. The result is that the sealing cups 22, 23 or their external lips will lift from the wall of the bore portion 12 and open the passage for the inflowing pressure fluid. Like in the closing operation, the contour of the annular chamber accommodating the sealing cup 22 will change only if the pressure difference applied to the sealing cup is insignificant. The closure member 7 is pressed further in an upward direction by the compression spring 14 until the force-transmitting member 27 again bears against the plate 8 closing the pleated bellows 2. Upon further filling of the chamber 4, the plate 8 will retreat, and the travel of the closure member 7 is limited by stop 17.

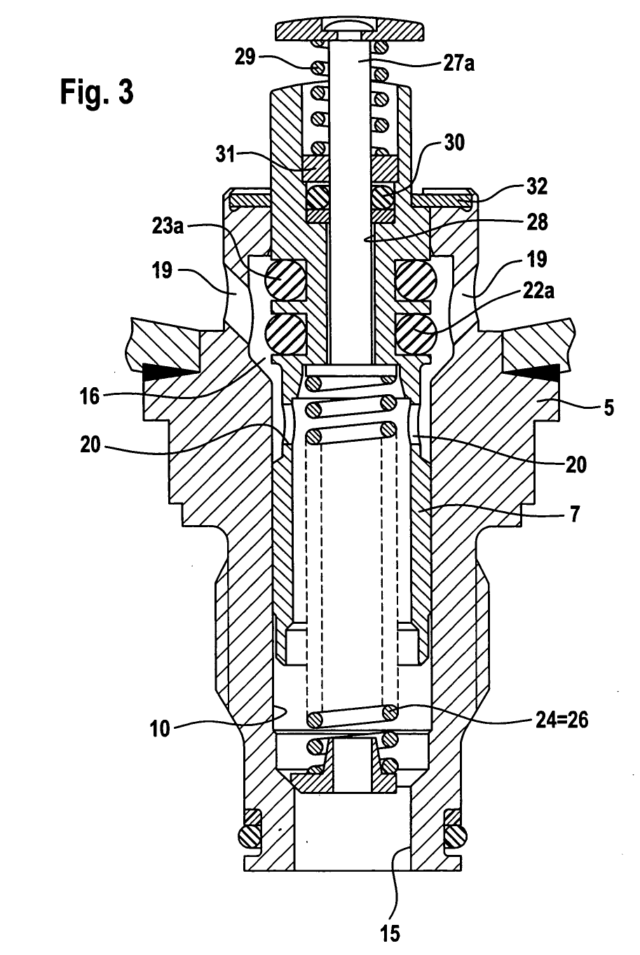

In the second embodiment of the bottom valve 6 illustrated in FIG. 3, like parts have been assigned like reference numerals. However, different from the embodiment shown in FIG. 2, the valve member 7 includes a bore 28 at its end close to plate 8, said bore being used to guide a preferably tappet-shaped force-transmitting member 27a extending through the bore. At the end of the force-transmitting member 27a close to the fill and discharge opening 15, the valve spring 24 is supported and thus performs both the function of the valve-opening spring and the function of the above-mentioned compression spring for reducing the force that acts on the closure member 7. An auxiliary spring 29 interposed between the closure member 7 and the force-transmitting member 27a takes care of overcoming the friction of the force-transmitting member 27a in bore 28 so that no relative movement of the force-transmitting member 27a to the closure member 7 takes place in the closing operation. The sealing elements 22a, 23a arranged at the closure member 7 are configured as simple, robust O-rings in the embodiment shown. Another O-ring 30, which is secured in the closure member 7 by means of a press-fitted steel ring 31, is used to seal the force-transmitting member 27a in the closure member 7. Another steel ring 32 press-fitted into closure member 7 is used as a stop for the stroke limitation of the opening movement of closure member 7.

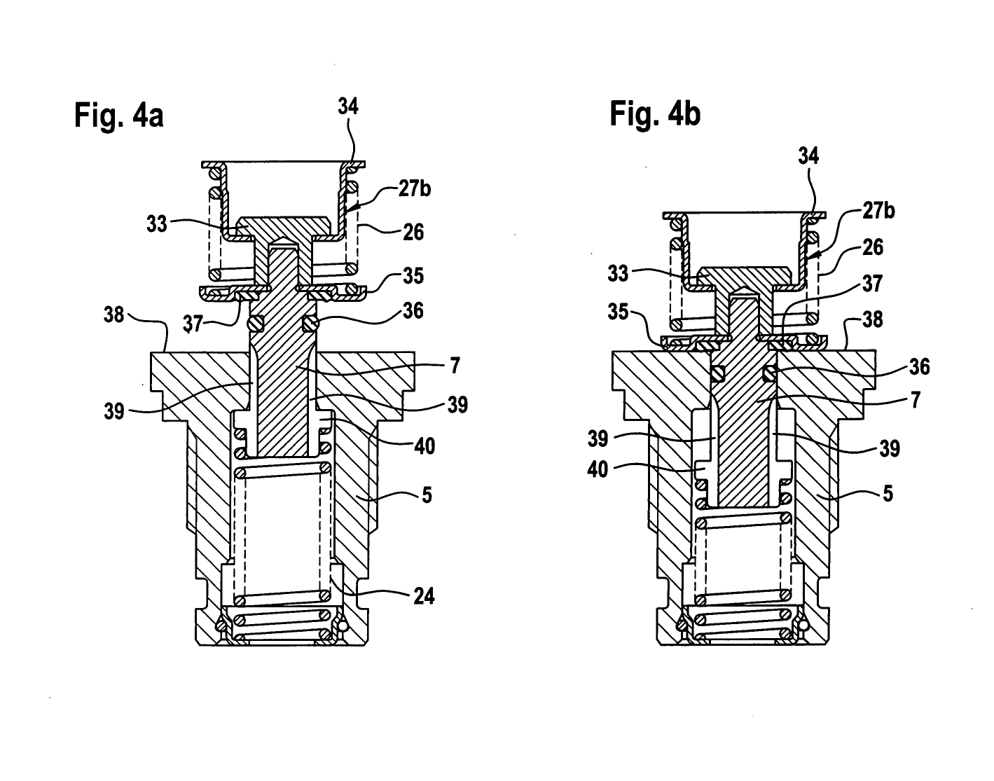

In the third embodiment of the bottom valve 6 illustrated in FIGS. 4a,b, the above-mentioned compression spring 26 is arranged outside the hydraulic port 5 coaxially relative to the closure member 7. The open position of the bottom valve 6 is illustrated in FIG. 4a, while FIG. 4b shows the closed position. The force-transmitting member 27b cooperates with a bead 33 designed at closure member 7 and includes a radial collar 34 on which the compression spring 26 is supported. The other end of the compression spring 26 is supported on a spring plate 35 secured to the closure member 7. An O-ring 36 arranged at the closure member 7 and a plate-type seal 37 arranged below the spring plate 35 are used to seal the closure member 7 in relation to the hydraulic port 5, said seal 37 being moved to abut on an annular surface 38 designed in the top area of the hydraulic port 5 in the closed condition of the bottom valve 6. The hydraulic connection between the fill or discharge opening 15 and the second chamber 4 (not shown) (see FIG. 1) is established in the embodiment shown by means of longitudinal grooves 39 designed in closure member 7. Another radial bead 40 designed in its bottom portion and additionally serving as a support of the valve spring 24 is used as a stop for the stroke limitation of the opening movement of the closure member 7.

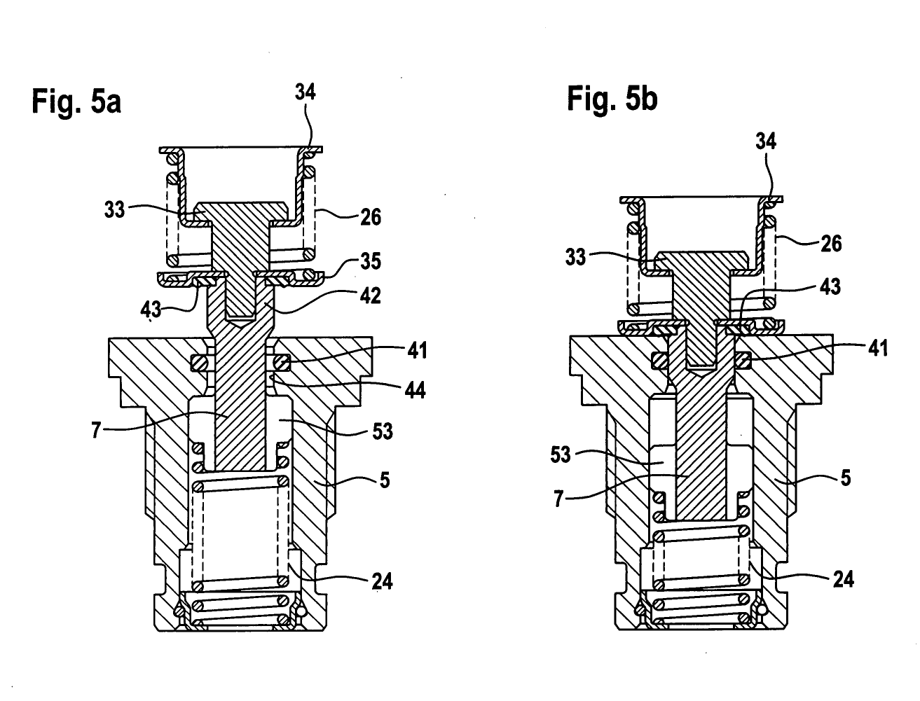

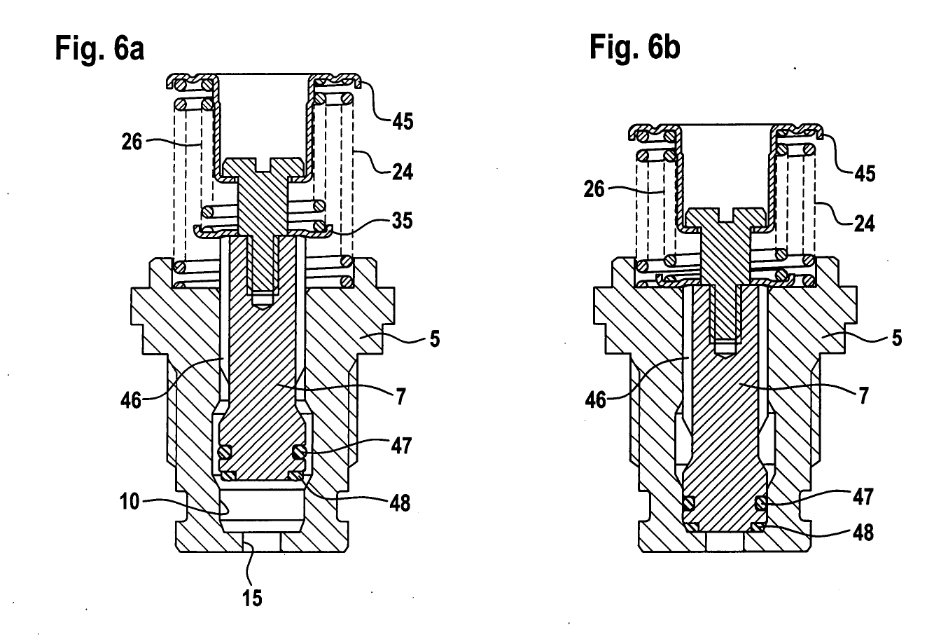

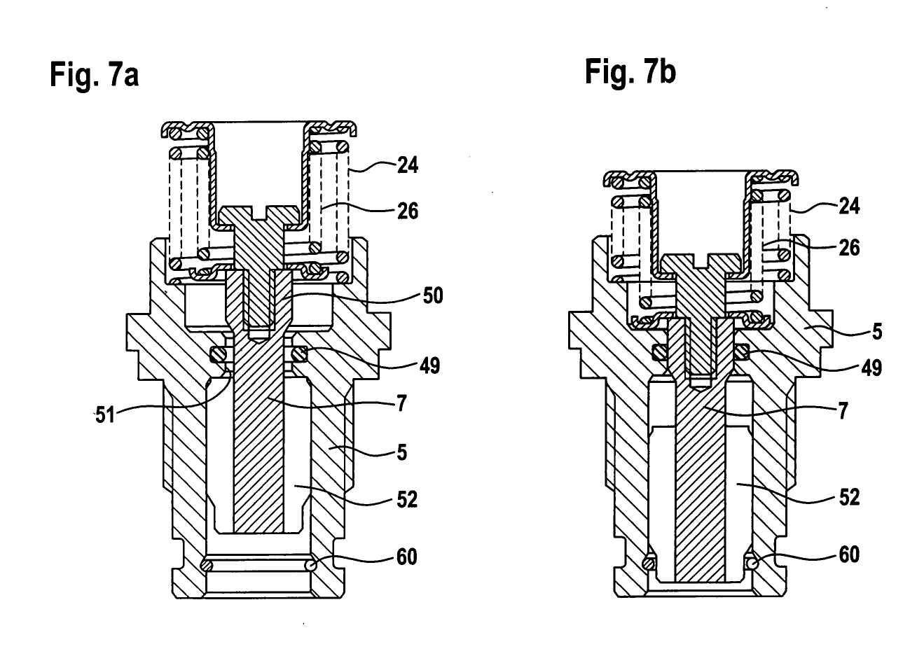

The design of the fourth embodiment of the bottom valve 6 as shown in FIGS. 5a,b corresponds largely to the design according to FIG. 4. The closure member 7 is sealed in relation to the hydraulic port 5 by means of an O-ring 41 arranged in an annular groove of the hydraulic port 5 and cooperating with a large-diameter portion 42 of the closure member 7 as well as the plate-type seal mentioned with respect to FIG. 4 that is designated by reference numeral 43 in FIG. 5. The hydraulic connection between the fill or discharge opening 15 and the second chamber 4 (not shown) (see FIG. 1) is established in the embodiment shown by means of a bore portion 44 of large diameter that is designed in the area of the O-ring 41.

In the fifth variant of the bottom valve 6 of the invention as illustrated in FIGS. 6a,b, the valve spring 24 and the above-mentioned compression spring 26 are arranged coaxially relative to each other in the area of the hydraulic port 5 that extends into the second chamber 4 (FIG. 1). The valve spring 24 preloading the closure member 7 in the opening direction has a larger diameter and is compressed between the hydraulic port 5 and a bowl-shaped force-transmitting member designated by reference numeral 45. The compression spring 26 that preloads the force-transmitting member 45 in relation to the closure member 7 has a small diameter and, like in the third or fourth embodiment, is compressed between the force-transmitting member 5 and the spring plate 35 mentioned with respect to FIG. 4. The hydraulic connection between the fill or discharge opening 15 and the second chamber 4 (not shown) (see FIG. 1) is established in the embodiment shown by means of flow ducts provided in the hydraulic port 5 and limited by guiding ribs 46 designed on the closure member 7. The mentioned connection is closed by means of a redundant sealing assembly secured at the closure member 7 and being formed of an O-ring 47 that seals in relation to the wall of bore 10 guiding the closure member 7, and of a plate-type seal 48. The plate-type seal 48 seals in relation to the hydraulic port 5. Guiding ribs 53 designed at the closure member 7 are additionally used as stop elements for the limitation of the stroke of closure member 7 in the opening direction of the bottom valve.

The design of the sixth embodiment of the bottom valve 6 as illustrated in FIGS. 7a, b corresponds largely to the embodiment according to FIG. 5, and the arrangement of the valve spring 24 and the compression spring 26 corresponds to the embodiment according to FIG. 6. However, only one O-ring 49 arranged in an annular groove of the hydraulic port 5 and cooperating with a large-diameter portion 50 of closure member 7 is used to seal the closure member 7 with respect to the hydraulic port 5. The hydraulic connection between the fill or discharge opening 15 and the second chamber 4 (not shown) (see FIG. 1) is established in the embodiment shown by means of a large-diameter bore portion 51 designed in the area of the O-ring 49. Guide ribs 52 designed on the closure member 7 are additionally used as stop elements for the limitation of the stroke of closure member 7 both in the opening and closing direction of the bottom valve 6, and the ‘bottom’ stop is provided by a circular clip 60 inserted in port 5. The stop may of course be also configured as e.g. a threaded sleeve screwed into port 5.

The seventh embodiment of the bottom valve 6 illustrated in FIGS. 8a, b corresponds largely to the embodiment according to FIG. 7. The only difference involves the type of sealing of the closure member 7 in relation to the hydraulic port 5 which is redundant in the embodiment shown and provided by two O-rings 54, 55 arranged one behind the other in annular grooves of the hydraulic port 5, said O-rings cooperating with correspondingly configured large-diameter portions of closure member 7.

Of course, other sealing assemblies of the bottom valve 6 are also feasible within the limits of the invention, which consist of combinations of sealing elements arranged on the closure member 7 and in the hydraulic port 5. Apart from the mentioned O-rings, multi-part seals such as metal rings with vulcanized rubber layers may also be used as sealing elements.

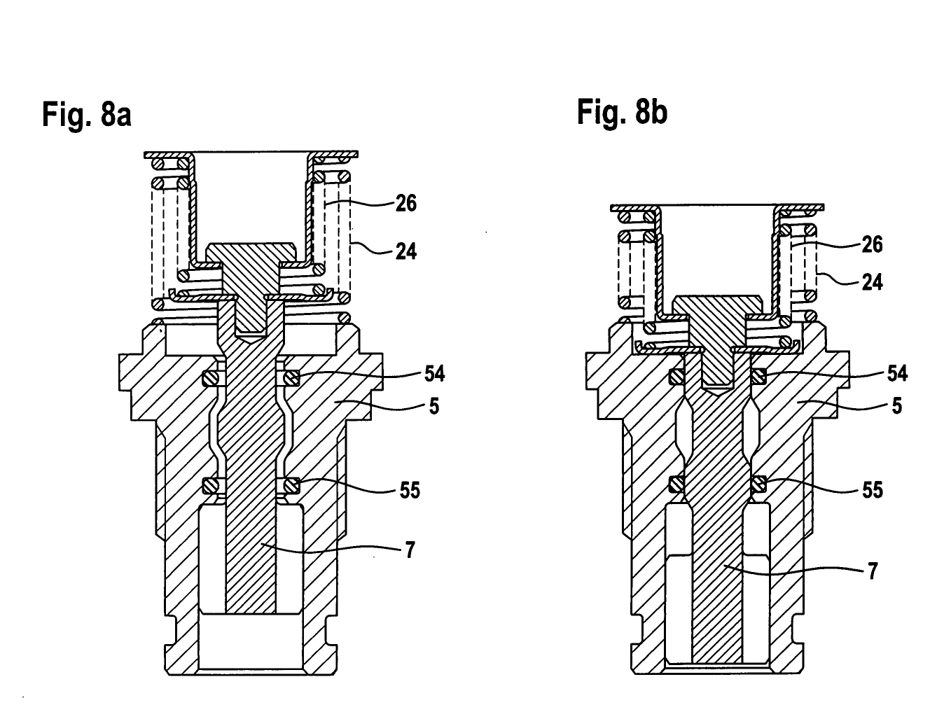

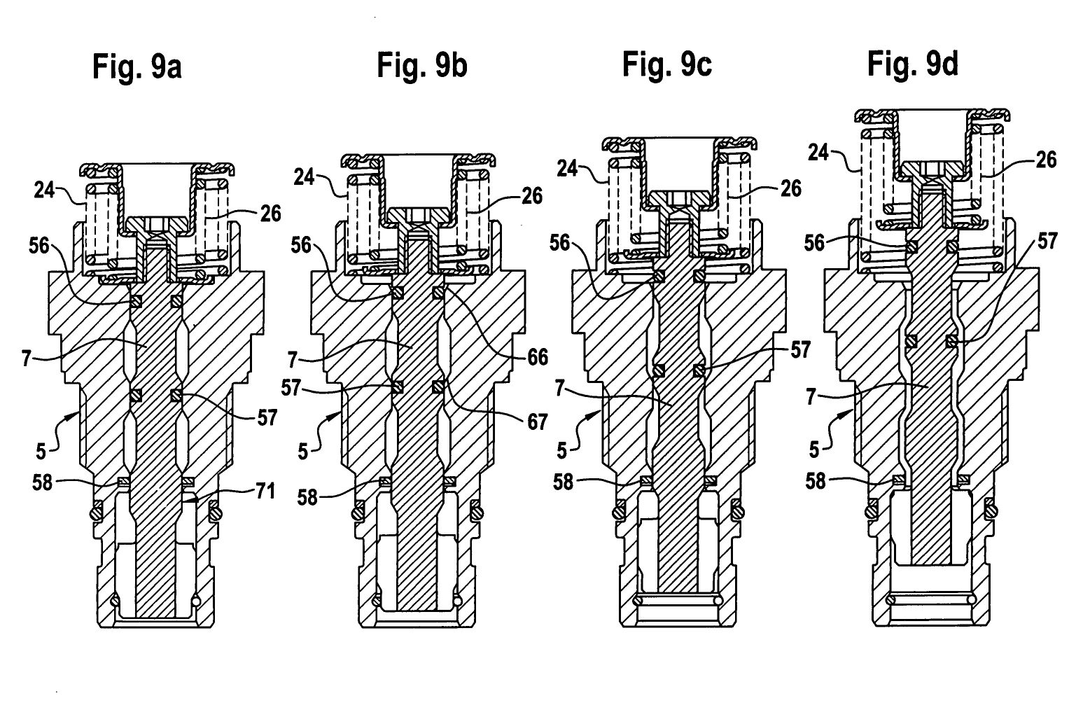

The eighth embodiment of the bottom valve 6 illustrated in FIGS. 9a to d corresponds largely to the embodiment according to FIG. 8. A means is provided in this embodiment, however, protecting the redundantly configured sealing assembly 56, 57 of the closure member 7 against being damaged by a high fill pressure in critical phases of operation of the bottom valve 6. For this purpose, an annular part 58 made of plastics, e.g. Teflon, or metal, is arranged in the hydraulic port 5 and limits an annular slot or a defined flow cross-section along with a portion 71 of the closure member 7. When the closure member 7 is moved during the filling operation from the closed valve piston (FIG. 9a) into the opening direction, a defined pressure fluid volume will flow through the above-mentioned annular slot so that the pressure acting on the sealing elements 56, 57 is reduced.

In the ‘critical’ actuating position depicted in FIG. 9b, the sealing elements 56, 57 move in the direct vicinity of edges 66, 67 designed in the hydraulic port 5, leaving the areas of the edges as the opening movement (FIG. 9c) continues. The slots produced at the edges 66, 67 are considered critical herein, through which slots the sealing elements 56, 57 would be slid under the effect of the otherwise high fill pressure and damaged or destroyed thereby. Only when the sealing elements 56,57 are disposed outside the ‘critical’ area will the annular part 58 release the full volume flow through the sealing elements 56, 57 (FIG. 9d).

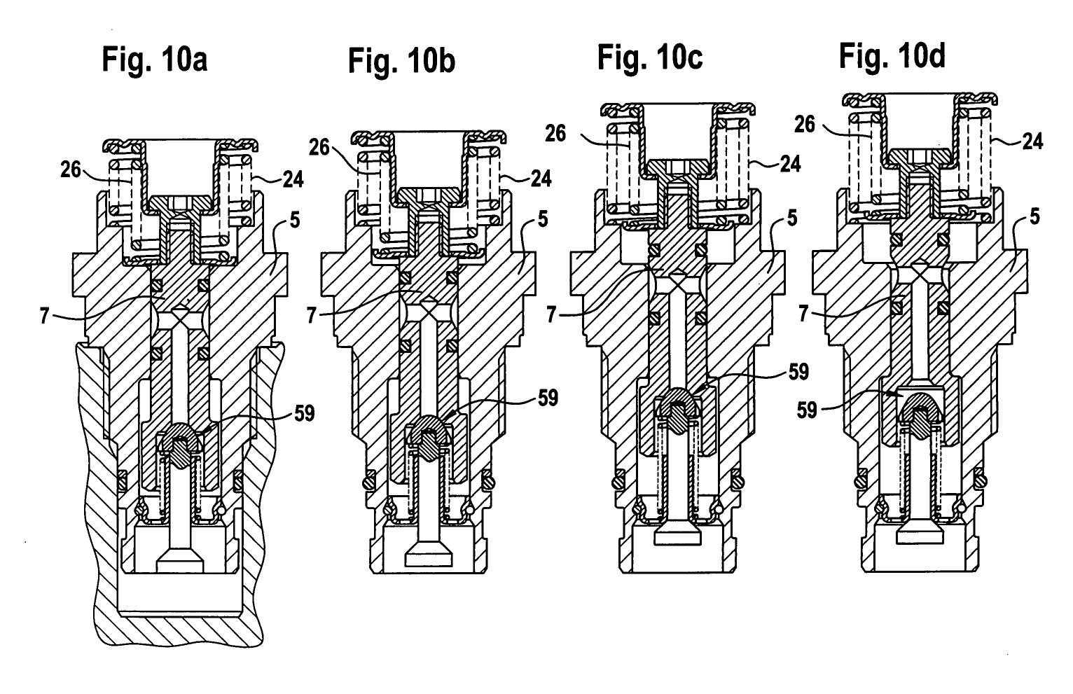

The representation of the individual phases of operation of the ninth embodiment of bottom valve 6 as shown in FIGS. 10a to d corresponds to the representation of the above-described embodiment according to FIG. 9. The means explained with respect to the embodiment according to FIG. 9, however, herein comprises a valve assembly 59, which is actuated by the opening movement of the closure member 7 of bottom valve 6. The valve assembly 59 in the embodiment shown is configured as a seat valve whose seat is designed in the closure member 7. Because the function of the valve assembly 59 corresponds to the mode of operation of the above-mentioned means and can undoubtedly be taken from the representation according to FIGS. 10a-d, it need not be explained in detail.

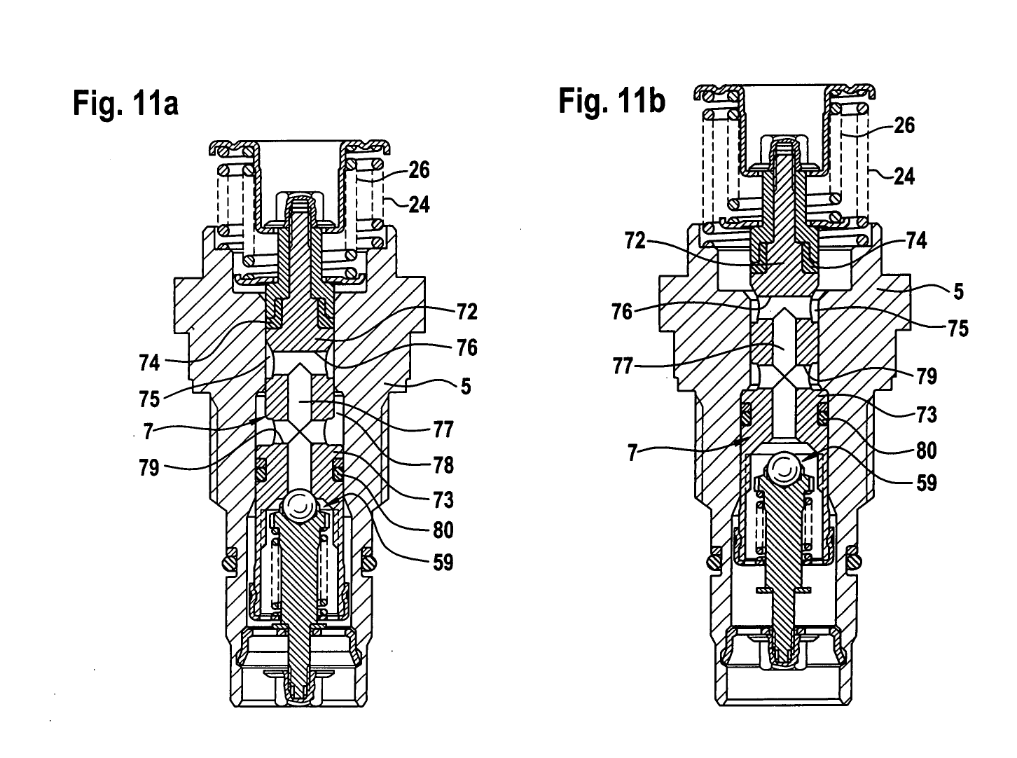

The illustration of the tenth embodiment of the bottom valve 6 as shown in FIGS. 11a, b corresponds to the representation of the above-described embodiments according to FIGS. 4 to 8, FIG. 11a showing the closed position of the bottom valve 6 and FIG. 11b showing the open position. The design of the embodiment shown basically corresponds to that of the ninth embodiment according to FIG. 10. The basic differences include above all the design of the closure member 7 and the function of the above-mentioned valve assembly 59. The closure member 7 is configured as a stepped piston and includes a first step 72 of small diameter and a second step 73 of larger diameter. The first step 73 carries the first sealing element 74 that is designed as a sealing sleeve with an L-shaped cross-section. An annular chamber 75 confined by the first step 72 in the hydraulic port 5 is connected by way of a transverse bore 76 to a flow duct 77 that axially extends in closure member 7 and whose end forms the seat of the valve assembly 59 designed as seat valve. In contrast thereto, the second step 73 confines in the bore of the hydraulic port 5 a second annular chamber 78 that is in connection with the flow duct 76 by means of a second transverse bore 79. The second sealing element 80 arranged on the second step 73 represents a combination formed of an O-ring and a back ring.

It can be taken from the illustration that the second step 73 produces an increase of the hydraulic pressure in the annular chamber 75 during the filling operation, whose value roughly corresponds to the value of the pressure that prevails in the pressure fluid accumulator. It is achieved thereby that the first sealing element 74 is pressure-balanced and there is no risk of damage by an excessive pressure. When the hydraulic pressure in the annular chamber 75 reaches a predeterminable value, the valve assembly 59, which additionally performs the function of a pressure relief valve, is briefly opened so that the pressure in the annular chamber 75 is reduced to an allowable value.

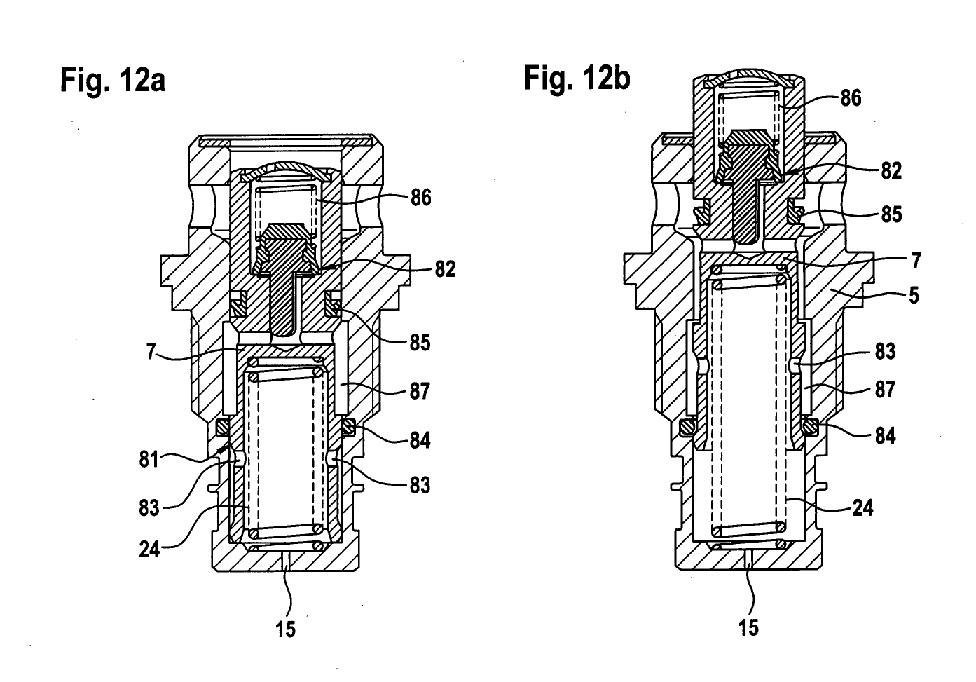

In the eleventh embodiment of the bottom valve 6 of the invention as illustrated in FIGS. 12a,b, the initially defined object of the invention is achieved by hydraulic means representing a series arrangement of two valve assemblies 81, 82 in the example shown. The first valve assembly 81 is formed of passages 83 designed in closure member 7 and a sealing element 84 that is immovably arranged in the hydraulic port 5, while the second valve assembly 82 is designed as a central valve arranged in closure member 7. The valve spring 86 of this central valve is preferably designed so that only a low differential pressure is necessary to open the central valve. The sealing element 85 arranged on the closure member 7 is designed as a sealing cup. The passages 83 are in connection to the fill and discharge opening 15 so that when they override the sealing element 84 during the opening movement of the closure member 7, the pressure fluid flows into an annular chamber 87 limited by the closure member 7 in the hydraulic port 5 and the filling pressure is applied to the central valve 82. Due to the effect of the pressure difference between the pressure in the annular chamber 87 and the pressure prevailing within the pressure fluid accumulator, the central valve 82 is opened and the filling pressure acting on the closure member 7 reduced.

1-18. (Canceled).

19. Pressure fluid accumulator, comprising:
a housing having its interior subdivided by a media-separating element into first and second chambers, wherein the first chamber is filled with a gas and the second chamber being filled with a liquid,
a hydraulic port containing a bottom valve that is fluid communication with said second chamber for filling the second chamber with the liquid, wherein said bottom valve includes a closed condition for preventing complete evacuation of the second chamber, wherein the valve includes a closure member preloaded in the opening direction by means of a valve spring being operable by the media-separating element,
means for reducing a force transmitted from the closure member of the bottom valve to the media-separating element, wherein said reducing means resides between the media-separating element and the bottom valve.

20. Pressure fluid accumulator as claimed in claim 19, wherein the reducing means is configured as a compression spring supported on the closure member of the bottom valve and adapted to abut the media-separating element.

21. Pressure fluid accumulator as claimed in claim 20, wherein the compression spring abuts the media-separating element by means of a force-transmitting member that is movable relative to the closure member and is slidably guided in the closure member.

22. Pressure fluid accumulator as claimed in claim 20, wherein the spring rate of the compression spring is greater than the spring rate of the valve spring.

23. Pressure fluid accumulator as claimed in claim 21, wherein the compression spring and the valve spring are the same spring.

24. Pressure fluid accumulator as claimed in claim 21, wherein the force-transmitting member includes a cylindrical guiding portion that extends through a bore designed in the closure member and whose end remote from the media-separating element abuts on the closure member under the preload of the valve spring.

25. Pressure fluid accumulator as claimed in claim 19, further including a sealing element designed as a non-return valve opening towards the second chamber in the closed condition of the bottom valve.

26. Pressure fluid accumulator as claimed in claim 25, wherein the sealing element is configured as a sealing cup.

27. Pressure fluid accumulator as claimed in claim 23; wherein the sealing element is configured as an O-ring.

28. Pressure fluid accumulator as claimed in claim 19, wherein the closure member includes two sealing elements arranged one after the other.

29. Pressure fluid accumulator as claimed in claim 19, further including:
means for throttling a pressure fluid volume flow to be supplied during a filling operation of the second chamber, wherein said means releases a full pressure fluid volume flow only after complete opening of the bottom valve.

30. Pressure fluid accumulator as claimed in claim 29, wherein the means is formed of an annular part and a portion of the closure member limiting a defined flow cross-section and cooperating in such a fashion that the flow cross-section is increased when the closure member moves in an opening direction of the bottom valve.

31. Pressure fluid accumulator as claimed claim 29, wherein the means is designed as a valve assembly operable by the closure member.

32. Pressure fluid accumulator as claimed in claim 31, wherein the valve assembly is configured as a seat valve having a seat in the closure member.

33. Pressure fluid accumulator as claimed in claim 31, wherein the closure member includes a first small-diameter step that carries a sealing element of the bottom valve and a second step of larger diameter, wherein said second step serves to increase the hydraulic pressure that acts on the first step during the filling operation, wherein the valve assembly is designed as a pressure relief valve which permits decreasing the hydraulic pressure acting on the first step in the event of its excessive increase.

34. Pressure fluid accumulator as claimed in claim 19, wherein the closure member of the bottom valve includes two serially connected valve assemblies, which permit decreasing the pressure that acts on the closure member during the filling operation, wherein the degree of said pressure decrease is, in part, a function of the actuation of the closure member in the opening direction of the bottom valve.

35. Pressure fluid accumulator as claimed in claim 34, wherein the first valve assembly is formed of passages in the closure member and being in communication with the fill or discharge opening, said passages—cooperating with an immovable sealing element—permitting a controlled pressure fluid volume flow to the second valve assembly that is designed as a central valve and permits a reduced pressure fluid volume flow into the second chamber before the bottom valve opens.

36. Pressure fluid accumulator as claimed in claim 19, wherein the media-separating element is a metallic pleated bellows.
